(19) United States
(12) Patent Application Publication
(10) Pub. No.: US 2005/0166035 A1
(43) Pub. Date: Jul. 28, 2005

(54) System and method for generating images on ferromagnetic materials

(76) Inventor: Jesse D. Crum, St. Fort Scott, KS (US)

Correspondence Address: WARD KRAFT, INC., P.O. BOX 938, FORT SCOTT, KS, 66701, US

(21) Appl. No.: 10/954,798

(22) Filed: Sep. 30, 2004

Related U.S. Application Data
(63) Continuation-in-part of application No. 10/766,729, filed on Jan. 28, 2004.

(51) Int. Cl. G06F 15/76

(52) U.S. Cl. 712/25; 710/5

(57) ABSTRACT

A system and method for creating magnetic remembrance items in an efficient manner is disclosed and includes a substrate having a printable face, a curable base layer and a magnetic core. The substrate may be divided into a number of predetermined areas with each of the areas separated from one another through the use of attenuating lines. The system captures an image, such as a photograph, at a first location and transmits the image to a second location where a digital press is located. A computer collects, manipulates the image and sends print signals to the digital press to render the image in at least one of the predetermined areas to create a removable remembrance element.

### CROSS-REFERENCES TO RELATED APPLICATIONS

This application is a continuation-in-part of application Ser. No. 10/766,729 filed Jan. 28, 2004 (having a common inventor and assigned to the same assignee as the present application) which is hereby incorporated by reference herein as is necessary for a complete understanding of the present invention.

### FIELD OF THE INVENTION

The present invention relates to a system and method for creating images, such as photographs and the like on a removable portion of a substrate having ferromagnetic properties. The substrate may be provided in either sheet form or a continuous format and may contain a number of predisposed or predetermined positions that are suitable for receiving discrete images, with each position surrounded by attenuating lines. The substrates may be fed easily to a variable or digital printing system which provides images to the substrate on processing.

### BACKGROUND OF THE INVENTION

The use of magnetic pieces and novelties has given rise to numerous magnetic products that are available in the marketplace today. Magnetic materials have become increasingly common in the business forms and labels industry for their ability to provide the customer with an advertising or remembrance piece that can be passed along or saved for future reference.

Today's growth of new technology plays a vital role in creating and providing businesses with laser compatible forms and products that can be used in a variety of businesses and industries. The rise in the interest of articles or items that have magnetic components has created an ever increasing demand for the availability of such products. This demand also has presented the manufacturer with the difficulties of including this auxiliary magnetic material with traditional forms and product stocks such as pressure sensitive materials.

In addition to the difficulties associated with having to add what amounts to a large “chunk” or piece of material, one which typically ranges from 12 to 14 mils, onto a substrate is that the magnetic materials when placed in a stack can create a sloped stack (one side of the stack higher than the other due to the increased thickness of the magnetic material) as well as a stack that is difficult to align or handle due to the magnetic fields created by the coercive forces between poles in successive magnetic sheets. This can cause the sheets to splay or shift out of alignment making repetitive and continuous feeding through processing equipment difficult and often substantially reducing the efficiency of a manufacturing operation to a series of incremental production of stops and starts so as to accomplish the completion of the job.

Magnets have been previously attached to materials and used for purposes of marketing and advertising. Some exemplary prior uses of magnets include calendars, business cards, and frames for photographs, advertising collateral and the like. One example of such a prior art construction is provided in U.S. Pat. No. 5,458,282. The construction includes a solid magnet that is attached to one end of a substrate and, placed between end edges of the substrate. The magnet is then separable from the substrate via a separation line. The difficulty associated with such prior art constructions is that this construction is often limited in usage to the one advertising arrangement provided with the assembly. That is, the magnet may contain a single business card or reference or contact number and the adjoining substrate may only include printed indicia related to that one event.

In addition, such a construction also requires a magnetic piece to be physically juxtaposed on to a substrate in order to use the product for its intended purpose, that of enabling the substrate to be applied to a metallic surface. Due to the increased thickness of the magnetic material, the substrate along with the magnet attached thereto cannot easily pass through a laser or other non-impact printer due to the “hump” or “bump” created by the magnet. This hump can distort the printing of the substrate and potentially cause excessive wear and tear to the print head of the printer due to the abrupt contact with the raised area of the magnet. Thus, the substrate must first be printed and then have the magnetic piece attached thereto. As might be expected, this can create alignment problems if the magnetic material is applied to the incorrect area of the substrate.

Another example similar to the foregoing construction is represented by U.S. Pat. No. 5,676,307 to Martin which teaches the use of a substrate to which a magnetic strip has been adhesively applied or juxtaposed entirely over one end of the substrate, but not the entire substrate. The magnetic material is again exposed and would be subject to coercive magnetic forces if the product were placed in a stacked configuration with other similar magnetic products. That is, there is no shield or gap to prevent the magnet of one sheet from interfering with the magnet of a successive sheet. The magnetic portion of the product is then separated through the use of one or more lines of weakness.

These products suffer from several drawbacks. Initially, the line of weakness creates a jagged edge arising out of the separation of the ties from one another in the area of the line of weakness. Where the product is to be used as a remembrance item, it is highly undesirable to have an item which produces a less than desirable aesthetic feature. Secondly, a construction having such a differential height arrangement can cause problems for printing and processing equipment as discussed above. While Martin proposes the use of a ramp or beveled edge to reduce this problem, the ramp or sloped edge has been provided on one edge of the magnetic strip, the edge that is adjacent the exposed or uncovered portion of substrate of the construction. This requires the feeding of the form in only a single direction so that the processing equipment can utilize the benefit of the sloped edge.

Another prior art product is provided in UK Patent Application 2,292,474 which discloses the attachment of a ceramic magnetic disc to the back of a business card, after the business card has been prepared. This allows a user the ability to create a magnetic business card after the card has been prepared or printed. Such a product configuration however requires that the user maintain a supply of imprintable card stock, magnets and a means to attach the magnet to the card stock material. In addition, the concept utilized by the '474 application would not enable the subsequent processing of the material due to the differential thickness of the magnet on the card or stock.

Other prior art solutions may utilize a sheet of magnetic material which may be printed upon. However, in order to process this particular construction the magnetic material is provided in a deadened state, one in which there is no readily discernable magnetic force or alternatively it is so weak that the magnetic material as provided is incapable of adhering to a metallic surface. Thus, the manufacturer after printing or processing the sheet must then “charge” the magnet so that it will have a sufficient force to adhere to a metal surface. As expected, the additional step of charging the magnet is time consuming and adds a further layer of expense to the offering being presented. In addition, even after the charging, the magnetic sheets are difficult to handle and cannot be wrapped in a flat stack as the coercive forces of each of the magnetic pole regions causes successive sheets to splay or shift out of alignment with one another.

Solutions to the issue of splaying have been to increase the size of the material that rests between the magnetic material or to use inserts which effectively mitigate the magnetic forces between sheets by separating the sheets a sufficient amount that the coercive forces do not interact. However, in addition to the added costs of the thicker material or inserts, there is the added cost associated with transporting and shipping the material due to the increased thickness or inserts.

A still further solution to this prior art problem was to use a thinner magnetic material, one which was capable of holding only a lesser magnetic force. This construction unfortunately suffers from the drawback that the magnet may not adhere to the desired surface due to the relatively weak field.

Where it has been tried to create an image on a magnetic sheet, that retains a charge, the charge present in the sheet can cause the sheet to migrate out of alignment with the image generator, thus causing the image to appear off center, or be partially cut off. This unfortunately leads to significant waste and disappointment. In addition, where such sheets can be successfully printed, the sheets have a tendency to “lock up” or stick together making quick separation and distribution difficult. However, this will then likely require the sheets to be magnetized after imaging leading to an increase in processing costs due to the extra handling required as well as the amortization of the equipment.

These particular constructions also rely on significantly thicker magnetic material in forming the substrate and as might be expected this substantially increases the weight of the material for shipping and handling purposes.

In creating remembrances such as photographs and other personal memorabilia, there has been a desire to image or produce images of subjects, such as students, children, families, sports teams, etc. and to create removable magnetic elements that have a clean, sharp peripheral edge that resemble a conventional photograph, but which do not require additional frames, adhesives and the like to hold the photograph. Such a product does not heretofore appear to be available.

What is needed therefore is a system and method for producing magnetic remembrance items from an easily processable substrate that overcomes the foregoing drawbacks and which facilitates the production of cleanly removable elements having a pleasing aesthetic presentation to the recipient.

Publications, patents and patent applications are referred to throughout this disclosure. All references cited herein are hereby incorporated by reference.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention provides a method and system for producing a unique item from a substrate created from a laminated configuration that is suitable for creating advertising, memorabilia, remembrance items, souvenirs and the like. The magnetic laminate when used in the present system of the present invention overcomes the foregoing drawbacks by producing a product that is readily and cleanly removable from the construction as well as provides a laminate that can be processed efficiently by a manufacturer or user without the necessity of supplemental processing steps or the inclusion of auxiliary materials or suffer from increased weight for shipping/handling purposes.

In one exemplary embodiment of the present invention a method of producing personalized magnetic products is described and includes the steps of initially providing a substrate that has magnetic properties. The substrate has a printable face, a backing that includes a curable coating and a magnetic core which is disposed between the printable face and backing. At least one image is captured at a first location, such as through the use of a digital camera, and then the image is transmitted from the first location to a second location that is remote from the first location where an image generating means is located. The image generating means may be a digital printing press. Then the substrate is processed at the second location through the image generating means to apply or print the image onto at least a portion of the substrate on the first face. Next, the portion of the substrate is removed to create a removable magnetic portion that contains the at least one image and the removable portion is associated with a customer order.

The foregoing embodiment may include the further of placing a series of substrates in a stack with the curable coating creating an air gap between successive magnetic layers of each of the substrates so as to facilitate the feeding and processing of the sheets through the image generating means. This step would occur prior to the step of processing the substrate through said image generating means.

It should also be understood that multiple images could be provided on the substrate through the use of the foregoing method and the subsequently described embodiment relating to the system. In addition, the images can be placed or printed in discrete or predefined areas that are separated from one another through the use of attenuating lines or the like.

In a further exemplary embodiment of the present invention a system for creating magnetic remembrance items is described and includes at least one substrate having a printable face and a curable base with a magnetic core disposed there between. The system also includes an image capture means, such as a digital camera, that located at a first location and an image generating means that is located at a second location, distinct from the first location. At least one image is captured by the image capture means and then the image is transmitted to a computer which is used for collecting, storing and manipulating the image as well as for issuing instructions to the image generating means. The computer also assigns customer order information to each image that includes machine readable indicia. The digital capture means, image generating means and computer are connected to one another through a transmission means which may include a local area network, wide area network, global communications network or combinations thereof.

The embodiments of the present invention are also intended to include the products, remembrance items that are created through the use of the system and method of the present invention.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a block diagram showing an exemplary flow of the method of the present invention;

FIG. 2 shows the face of an exemplary substrate used in connection with the present invention;

FIG. 2A illustrates a cross section of the substrate used in the present invention; and

FIG. 3 provides a system for carrying out the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

As used herein the term “remembrance” item, article or element includes but is not limited to memorabilia, advertising and marketing collateral, souvenirs, tokens, trophies and certificates, keepsakes, reminders and generally other images and indicia that are intended to call to mind something about the provider of the product or the image or indicia printed or produced on the surface of the product.

As used herein the terms “capture” or “generating” as it relates to the capture, generation or collection of images can include digital means, cameras, scanners, optical devices and such other means as are necessary to collect images indicia or the like for subsequent rendering to the surface of the laminate of the present invention. The steps of imaging and capturing can be accomplished substantially simultaneously or may occur independently from one another. The image generating means refers to a digital press such as is available from Indigo, a division of Hewlett Packard of Palo Alto, Calif.

The substrate of the present invention, when provided in sheet format will typically come in one of a number of formats or sizes, such as 8½″ by 11″, 11″ by 17″, 8½″ by 14″ and other sizes that can be accommodated by a printing or imaging device. In a roll or continuous format the diameter of the roll may be any diameter for which the processing equipment may handle such as for example up to a 60 inch roll.

The substrate may be provided with a number of predetermined areas for placement of the image or images. Each of these areas may be of similar size or dimension or the areas may have different sizes, such as 8×10, 3×5, 1×2, and such other dimensions as are needed for production. In addition, the predetermined areas may also take any sort of shape or configuration, such as geometric shapes, animate and inanimate objects and the like.

An exemplary coating that is used to create the back surface of the substrate that is used in connection with the present invention is a UV curable coating distributed under the product name FT30LI and is available from Northwest Coatings Corp., Oak Creek, WI 53154 and is composed of various acrylate monomers and oligomers. The coating maintains a boiling point of greater than 200° C., a vapor density of greater than 1 (air=1), an evaporation rate of greater than 1 (n-Butyle Acetate=1) and a vapor pressure of less than 1 (MM HG at 25° C.). The coating is not an adhesive coating but rather creates a temporary bond which when separation force is applied, the bond breaks allowing the layers or pieces to be removed. Once broken, the layers or bond cannot be re-adhered to one another.

The production of the substrate that is used in the present invention is relatively straight forward and includes the provision of a material that will make up the backing layer of the laminate, such as a translucent sheet of glassine or machine glazed or machine finished paper having a thickness ranging from about 1 mil to about 3 mils. The UW curable coating is applied to the layer or sheet in a thickness ranging from about 0.0001 mils to 3 mils with about 0.01 to 1 mils being preferred and 0.5 mils being still more preferred. Next, a top construction, consisting of a combination of a magnetic layer with a printable face is applied and is placed in registry and alignment with the release sheet or backing so as to create an intermediate laminate, in which the sheets or layer have not yet been bonded together.

The top portion of the substrate which is a laminate is prepared by advancing the a first layer, for example a 20 pound bond stock, which may have an adhesive applied thereto along with the magnetic layer and then joining the two layers together such as at a nipping arrangement. Alternatively, the adhesive may be provided on the second layer rather than the first layer.

The coating may be applied throughout the entire area of the third layer so as to create an entire coated sheet or a substantially coated sheet or the coating may only appear in the area of the predefined areas created through the use of attenuating lines, lines of weakness, die cuts and the like that form the removable pieces or other elements. The die cuts or attenuating lines as shown in FIGURES are typically only applied to the first and second layers as the bottom sheet or third layer with the curable coating forms a carrier layer which will remain with the matrix of the top sheet once the removable elements have been removed. That is, once the removable piece has been separated from the construction, the surrounding area which makes up the residual matrix remains in the laminate or sheet. The die cuts that are used to create the removable pieces may be provided in such a manner so that the removable elements are substantially adjacent one another, that is the removable pieces may share a common die line or alternatively, the die cuts may be provided so that the removable pieces are separate from one another thereby leaving a matrix. Additional information concerning the manufacture of the substrate of the present invention can be found in U.S. patent application Ser. No. 10/766,729 filed Jan. 28, 2004 (having a common inventor and assigned to the same assignee as the present application) which is hereby incorporated by reference herein as is necessary for a complete understanding of the present invention.

Unexpectedly, it has been found that the coating that is used in creating the substrate of the present invention creates a sufficient air gap or magnetic void (an area where there are no magnetic forces or where the magnetic forces are substantially diminished so as to not interfere with successive sheets in a stack having a magnetic component) such that the combination of the gap and first and third layers of the substrate create a degree of separation ranging from about 4 to around 7 mils and more particularly between about 5 and approximately 6 mils. That is, the first layer has a thickness of about 2 mils, the third or release layer with coating has a thickness of about 3 mils and the coating a thickness of around 0.5 mils. This creates a ratio of magnetic material to air gap of approximately 1.2 to 1. For further information relating to the creation of the substrate, reference is directed to U.S. patent application Ser. No. 10/766,729 filed Jan. 28, 2004 (having a common inventor and assigned to the same assignee as the present application) which is hereby incorporated by reference herein as is necessary for a complete understanding of the present invention.

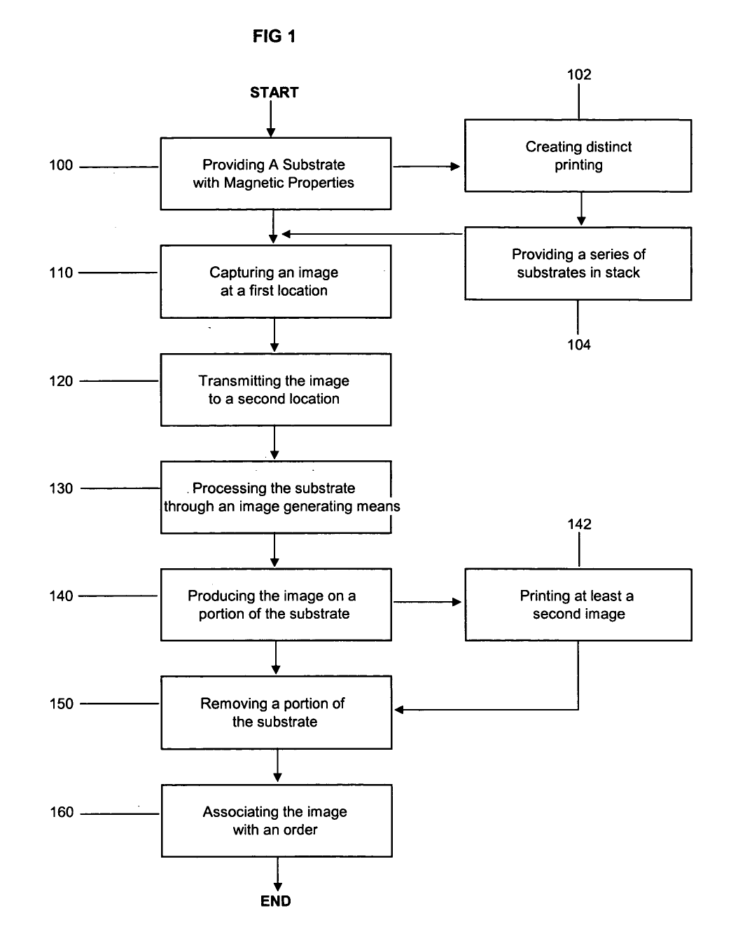

Reference is now directed to FIG. 1 of the present invention which provides a block, flow diagram illustrating the steps of practicing the present invention. The process is initiated by the indicia “start.” At least one substrate having magnetic properties is provided at step 100. A series of predefined or predetermined areas may be created in the substrate at step 102 such as through the use of attenuating lines, lines of weakness, die cuts or the like. In the event the manufacturing or production run requires a plurality of orders to be fulfilled, a stack of sheets may be collected and supplied at step 104.

Next, an image is captured at step 110. The image capture device is preferably a camera, such as a digital camera, but other devices may be used to capture an image such as a scanner, picture phone, or such other means that can capture and transmit and image. As used herein an image refers to a picture, graphics, text or combinations thereof. The image capture will normally occur at a first location, such as a school, gathering, athletic event, or any other place where a desirable image may be obtained. Once the image has been captured by the image capture device at step 110 it is then transmitted to a second location at step 120 which is preferably located at a distinct or second location remote from the first location. The second location is preferably a manufacturing location where a series of image generation units are located.

Once the image or images have been received at the second location, the substrate or substrates are processed through an image generator at step 130. The image generator is preferably a digital press such as are available from Indigo, a division of Hewlett Packard of Palo Alto, Calif. Next, the image or images are produced at step 140 on the digital press. The image may be printed or rendered in a single area or may be printed in multiple distinct areas to produce a number of removable elements. In addition, multiple images may be created and provided over the surface area of the substrate. Where multiple images are to be provided, this is accomplished substantially simultaneously at step 142.

Next, portions of the substrate that have the image or images produced thereon are removed at step 150 and the removed pieces with the images provided thereon are associated with order at step 160 such as through the use of machine and or human readable indicia that would have been printed on the substrate at the time of imaging.

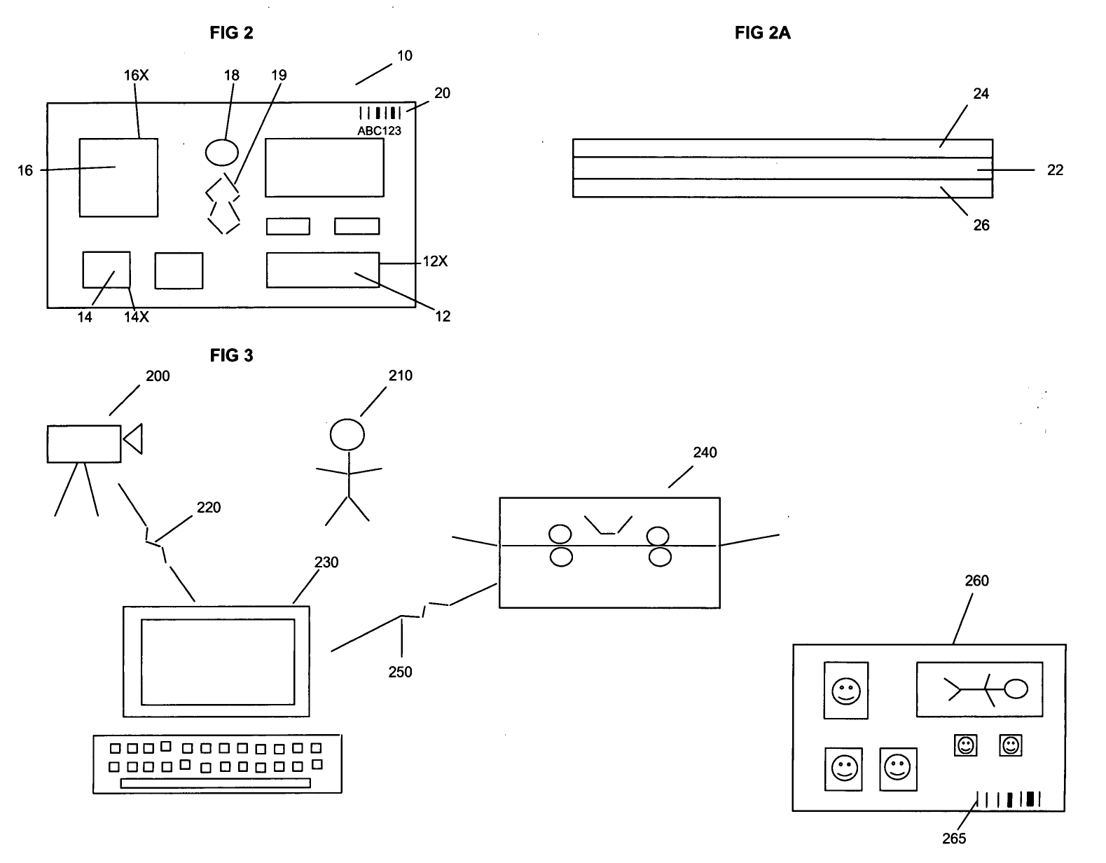

Reference is now directed to FIG. 2 of the present invention, which shows a front or face of the substrate that is used to carry out the invention. The substrate 10 is shown with a number of predefined areas 12, 14 and 16 which are created through the use of attenuating lines, lines of weakness, perforation lines 12*, 14* and 16* respectively. As previously discussed, the lines of attenuation extend only through the top portion of the substrate and do not extend entirely through the construction. Thus, each of the predefined pieces can be removed easily from the substrate while the remainder of the substrate or the matrix remains affixed to the carrier or back layer of the construction.

Also as shown in FIG. 2, the substrate is printed with order identification indicia 20, such as human (alpha and numeric characters) and or machine readable indicia, e.g. a bar code.

FIG. 2 further provides that the predetermined areas or removable sections may be generally square or rectangular or the areas may take on other geometric shapes 18 or animate or inanimate shapes 19 which may be suited to the particular configuration requested by the customer or offered by a manufacturer. In this manner, images can be created on magnetic pieces that have a more aesthetic appeal or can relate to a particular event or undertaking. For example, if a child athlete plays on the “stars” athletic team, the image of the child can be printed on a star shaped removable element. If portions of the image exceed the shape, such as the background or back drop portion then the excess portion of the image remains with the matrix portion of the substrate when the removable portion is separated from the substrate.

Turning now to FIG. 2A, the layers of the substrate are provided in a laminated configuration which includes a magnetic core 22, that has a thickness of less than 12 mils, a top printable layer 24 and a back layer 26 which includes a curable UV coating that serves to bond the layers together and facilitate processing through the image generation means. As indicated previously, the coating provides or creates an air gap where successive substrates are placed in a stack, such as would be required for an infeed tray for printer. However, it should be understood that the air gap that is being created, would likely also facilitate the unwinding from a roll if the substrate were to be provided in a continuous format.

FIG. 3 of the present invention presents a schematic illustration of the system utilized in practicing the present invention. It should be understood that other components of course may be added, such as scanner, databases for storing supplemental or complimentary files to include with the images, such as scenic or colored backgrounds and the like.

The system depicted in FIG. 3 includes an image capture device 200, such as a digital camera, that is used to capture an image 210, such as a student, athlete, scenery, etc. The image is then held in temporary storage in the capture device 200, as will be understood by those with skill in the art, until it is transmitted by a transmission means 220 to a computer 230. This may be accomplished by placing the camera in a docking station and then transmitting the image or images over a phone line to a production facility.

The transmission means may be selected from the group including a local area network, wide area network, global communications network or combinations of these. The computer 230 is preferably a standard PC such as is available from Dell Computer, Gateway or IBM. The computer 230 is used to capture, manipulate and prepare the image for processing by the image generation means 240 (digital press). The computer 230 transmits the image or images to be processed to the press 240 through transmission means 250 as described above. The substrate is processed through the press 240 and to produce a substrate 260 having a number of images disposed in predefined areas. The areas are then removed from the substrate 260 and are associated with a customer order through use of machine and or human readable indicia 265 which is printed substantially simultaneously with the image or images themselves.

It will thus be seen according to the present invention a highly advantageous method and system for creating removable magnetic remembrance items has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method of producing personalized magnetic products, comprising the steps of;
providing at least one source of a substrate having magnetic properties, said substrate having a printable face, a backing including a curable coating and a magnetic core disposed there between;
capturing at least one image at a first location;
transmitting said image from said first location to a second location;
processing said substrate at said second location through an image generating means;
producing said image on at least a portion said printable first face of said substrate;
removing said portion of said substrate to create a removable magnetic portion containing said at least one image; and
associating said removable magnetic portion with a customer order.

2. A method as recited in claim 1, wherein said image generating means is a digital press.

3. A method as recited in claim 1, wherein said first location is distinct from said second location.

4. A method as recited in claim 1, wherein said curable coating is cured by ultra violet energy.

5. A method as recited in claim 1, including a further step of creating distinct positions in said substrate with each of said portions being defined by attenuating lines, substantially simultaneously to the step of providing a substrate.

6. A method as recited in claim 1, including a further step of placing a series of substrates in a stack with said curable coating creating an air gap between magnetic layers of successive substrate sheets prior to the step of processing said substrate through said image generating means.

7. A method as recited in claim 1, wherein said image is selected from a group including photographs, graphics, text and combinations thereof.

8. A method as recited in claim 1, including a further step of including a further step of printing a least first and second images on said substrate in distinct areas from one another.

9. A method as recited in claim 8, wherein said first and second images have different dimensions.

10. A method as recited in claim 1, wherein said magnetic core has a thickness of less than 12 mils.

11. A method as recited in claim 1, wherein said substrate is printed with machine readable indicia in addition to said image.

12. A system for creating magnetic remembrance items, comprising;
at least one substrate having a printable face and a curable base with a magnetic core disposed there between;
an image capture means located at a first location;
an image generating means located at a second location, distinct from said first location;
at least one image captured by said image capture means;
a computer for collecting, storing and manipulating the image and for issuing instructions to said image generating means, said computer further assigns customer order information to each image; and
transmission means for transmitting said image from said image capture means to said computer.

13. A system as recited in claim 12, wherein said image capture means is a digital camera.

14. A system as recited in claim 12, wherein said image generating means is a digital press.

15. A system as recited in claim 12, wherein said transmission means is selected from a local area network, wide area network, global communications system and combinations thereof.

16. A system as recited in claim 12, wherein the substrate includes a number of predefined, distinct areas that are separated from one another by attenuating lines.

17. A system as recited in claim 16, wherein said areas have shapes selected from a group including geometric, animate, inanimate and combinations thereof.

18. A system as recited in claim 16, wherein images are provided in each of said areas.

19. A system as recited in claim 12, wherein said customer order information includes machine readable information.

20. A magnetic remembrance product produced by the method according to claim 1 in which the remembrance item has a shape selected from a group including animate, inanimate, geometric or combinations thereof.
